(19) United States
(12) Patent Application Publication
(10) Pub. No.: US 2024/0283786 A1
(43) Pub. Date: Aug. 22, 2024

(54) INFORMATION PROCESSING APPARATUS, INFORMATION PROCESSING SYSTEM, INFORMATION PROCESSING METHOD, AND STORAGE MEDIUM

(71) Applicant: CANON KABUSHIKI KAISHA, Tokyo (JP)

(72) Inventor: TAKASHI FUJINAGA, Kanagawa (JP)

(21) Appl. No.: 18/443,147

(22) Filed: Feb. 15, 2024

(30) Foreign Application Priority Data
Feb. 21, 2023 (JP) 2023-024959

(51) Int. Cl. H04L 9/40

(52) U.S. Cl. CPC H04L 63/083

(57) ABSTRACT

An information processing apparatus includes one or more memories and one or more processors. The one or more processors and the one or more memories are configured to receive a registration request including an email address and a password from a user terminal, and perform a registration process that registers an account of a user using the registration request, wherein the registration process includes performing processing to prompt the user to input additional information to the user terminal before registering the account in a case where a domain of the email address included in the registration request matches a predetermined domain.

### BACKGROUND

### Field of the Disclosure

The present disclosure relates to a technique for registering a user.

### Description of the Related Art

In a web service, a new registration of a user is performed using a user's email address and a password. There are some email addresses that may become unusable due to a change of a user's contract type. In many cases, an email address (so-called, carrier email address) based on a mobile phone contract may become unusable in general when the user changes their mobile phone. Further, an email address that a user is allowed to use in association with their Internet line contract may become unable to be used by the user when any change is made to the contract. Further, in many web services, as a rescue measure for a user who has forgotten their password, an operation procedure is prepared in which a link or a temporary passcode to reset the password is sent to the registered email address to allow the user to reset the password. Further, as another rescue measure, Japanese Patent Application Laid-open No. 2018-41347 discusses a method of using a secret question related to a user.

As described above, in the case where the user cannot use their email address due to the change of the contract type, the user cannot reset the password using the registered email address. Thus, in a case where the user has forgotten their password and the registered email address is not usable, the user ends up losing a recovery method for the user's account. With a method using a secret question related to a user as discussed in Japanese Patent Application Laid-open No. 2018-41347, the number of items to be input when the user performs a new registration increases. Accordingly, it takes time and labor to input the items, which may increase a rate at which the user abandons the new registration (abandonment rate) before completing the input.

### SUMMARY

Some embodiments of the present disclosure are directed to a technique for reducing a risk that a user becomes unable to reset a password of the user after registration, while maintaining user convenience in a new registration as much as possible.

According to an aspect of the present disclosure, an information processing apparatus includes one or more memories and one or more processors. The one or more processors and the one or more memories are configured to receive a registration request including an email address and a password from a user terminal, and perform a registration process that registers an account of a user using the registration request, wherein the registration process includes performing processing to prompt the user to input additional information to the user terminal before registering the account in a case where a domain of the email address included in the registration request matches a predetermined domain.

Further features of various embodiments of the present disclosure will become apparent from the following description of exemplary embodiments with reference to the attached drawings.

### BRIEF DESCRIPTION OF THE DRAWINGS

FIG. 1 is a diagram illustrating an example of an entire configuration of an information processing system.

FIGS. 2A and 2B are block diagrams each illustrating an example of a hardware configuration of an apparatus.

FIGS. 3A and 3B are block diagrams each illustrating an example of a functional configuration of the information processing system.

FIGS. 4A and 4B are tables illustrating information managed in each storage unit.

FIG. 5A is a diagram illustrating an example of a screen displayed on a client terminal.

FIGS. 5B-A and 5B-B are diagrams each illustrating an example of a screen displayed on the client terminal.

FIG. 6A is a flowchart illustrating new registration processing.

FIGS. 6B-A and 6B-B are flowcharts each illustrating recovery information input prompt processing.

FIGS. 7A to 7D are diagrams each illustrating an example of a screen displayed on the client terminal.

FIGS. 8A-A and 8A-B are flowcharts each illustrating processing performed in response to a password reset request.

FIGS. 8B-A and 8B-B are flowcharts illustrating user authentication processing and password reset processing, respectively.

### DESCRIPTION OF THE EMBODIMENTS

Hereinbelow, exemplary embodiments for implementing the present disclosure will be described with reference to the drawings.

Some embodiments of the present disclosure will be described below in detail with reference to the attached drawings. In addition, configurations described in the following exemplary embodiments are merely examples and some embodiments are not limited thereto.

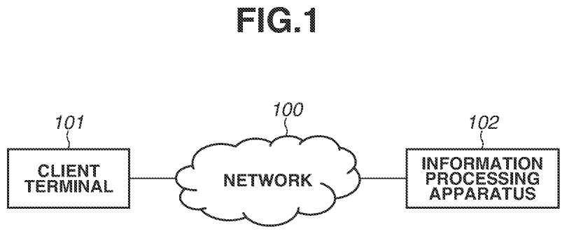

FIG. 1 is a schematic diagram illustrating an example of an entire configuration of an information processing system according to an exemplary embodiment. The information processing system includes a client terminal 101 and an information processing apparatus 102. The client terminal 101 and the information processing apparatus 102 are communicably connected to each other via a network 100.

The client terminal 101 is an information processing terminal having a communication function that is available for use by a user, such as a smartphone and a personal computer (PC). The client terminal 101 is an example of a user terminal. The client terminal 101 displays, via a browser, a web page returned from the information processing apparatus 102 to receive an input from the user. Further, the client terminal 101 calls an application programming interface (API) for a web application hosted by the information processing apparatus 102, in response to a request issued by the user via the web page provided by the information processing apparatus 102.

The information processing apparatus 102 is, for example, a server apparatus, but is not limited to a physical server apparatus and may be a virtual server apparatus.

The information processing apparatus 102 manages a web application used by a user, and returns a web page to the client terminal 101.

Further, the information processing apparatus 102 provides to the client terminal 101 an API for executing new registration processing and password resetting processing illustrated in flowcharts to be described below. Further, the information processing apparatus 102 has a function of storing user information or the like required for the operation of the web application.

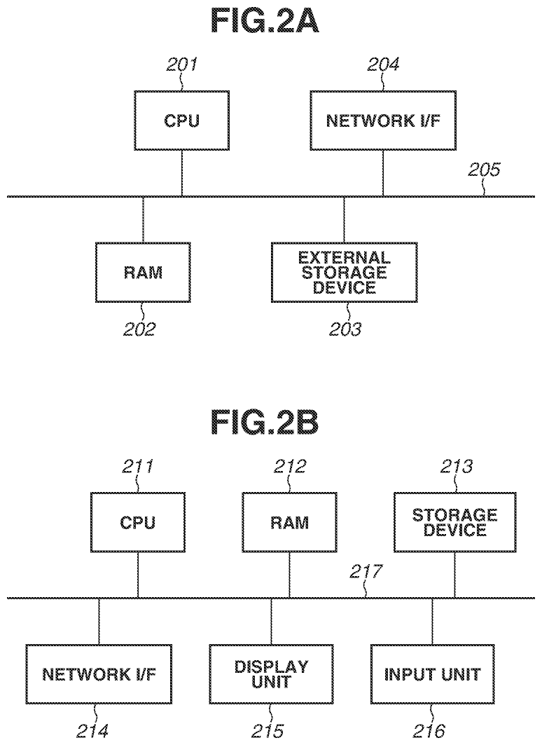

FIGS. 2A and 2B are block diagrams each illustrating an example of a hardware configuration of each apparatus included in the information processing system according to the present exemplary embodiment. FIG. 2A is a block diagram illustrating an example of the hardware configuration of the information processing apparatus 102. The information processing apparatus 102 includes a central processing unit (CPU) 201, a random access memory (RAM) 202, an external storage device 203, and a network interface (I/F) 204. These components are connected with each other via a bus 205.

The CPU 201 controls the entire information processing apparatus 102. Various functions of the information processing apparatus 102 and processing of flowcharts described below can be implemented by the CPU 201 reading a program stored in the external storage device 203 into the RAM 202 and executing the read program. The RAM 202 is a volatile memory for temporarily storing data, and functions also as a work area to load data when the CPU 201 executes the program. The external storage device 203 is a non-volatile memory, such as a magnetic disk and a flash memory, to store programs and various kinds of information. The network I/F 204 is connected to the network 100, and transmits and receives data to and from other apparatuses on the network 100 under the control of the CPU 201.

FIG. 2B is a block diagram illustrating an example of the hardware configuration of the client terminal 101. The client terminal 101 includes a CPU 211, a RAM 212, a storage device 213, a network I/F 214, a display unit 215, and an input unit 216. These components are connected with each other via a bus 217.

The CPU 211 controls each unit of the client terminal 101 by loading a program stored in the storage device 213 into the RAM 212 and executing the loaded program. Further, the CPU 211 is operable as a client that can access the information processing apparatus 102 by executing a program, as will be described below. The CPU 211 transmits a Hypertext Transfer Protocol (HTTP) request to the information processing apparatus 102, and receives a response to the request. The RAM 212 is a volatile memory for temporarily storing data, and functions also as a work area for loading data when the CPU 211 executes a program.

The storage device 213 is a non-volatile memory and stores programs and various kinds of information. The network I/F 214 is connected to the network 100, and transmits and receives data to and from other apparatuses on the network 100 under the control of the CPU 211. The display unit 215 is a display that displays web pages provided from the information processing apparatus 102 under the control of the CPU 211. The input unit 216 is a keyboard, a mouse, or a touch panel and receives an operation from a user.

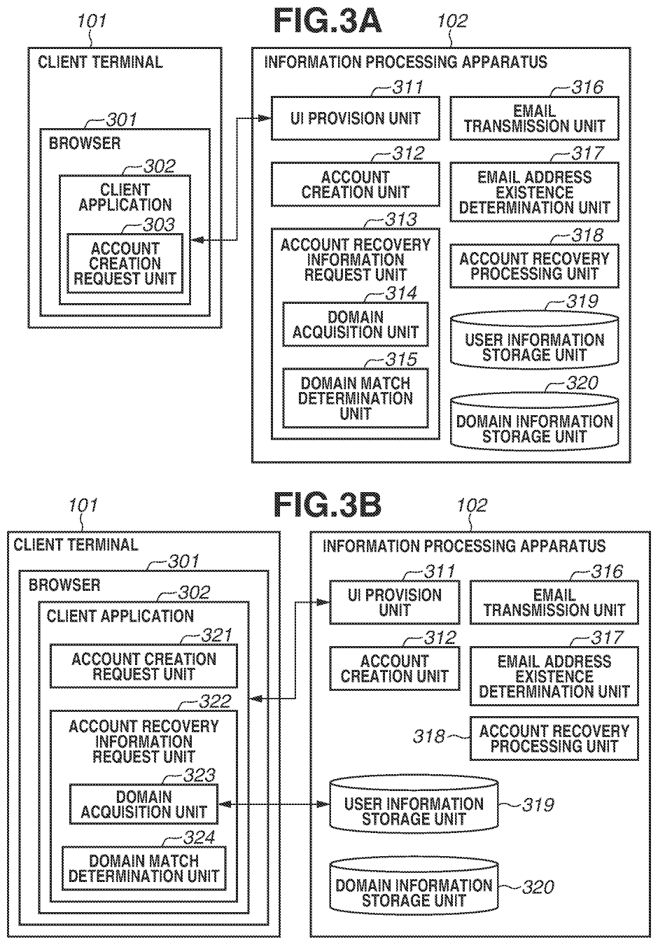

FIGS. 3A and 3B are block diagrams each illustrating an example of a functional configuration of the information processing system according to the present exemplary embodiment. FIGS. 3A and 3B are different in whether an account recovery information request unit to be described below functions on the client terminal 101 side or functions on the information processing apparatus 102 side. FIG. 3A illustrates an example of the functional configuration of the information processing system in a case where the account recovery information request unit functions on the information processing apparatus 102 side.

First, a functional configuration of the client terminal 101 in FIG. 3A will be described. As illustrated in FIG. 3A, the client terminal 101 has a function of a browser 301.

The browser 301 displays, on the display unit 215, various kinds of user interface (UI) screens provided from the information processing apparatus 102, and receives a user input via the input unit 216. Further, the browser 301 controls the operation of a client application 302 in response to an input from a user. In a case where the client application 302 performs processing in cooperation with the information processing apparatus 102, the client application 302 is provided from the information processing apparatus 102 and operates via the browser 301. The client application 302 includes an account creation request unit 303. When an account is newly registered, the account creation request unit 303 transmits an account creation request including information required for the account creation, to the information processing apparatus 102. The account creation request is a request for an account registration.

Next, a functional configuration of the information processing apparatus 102 in FIG. 3A will be described. In FIG. 3A, respective functions of the units in the information processing apparatus 102 in FIG. 3A are implemented by the CPU 201 of the information processing apparatus 102 executing a program stored in the external storage device 203. More specifically, the information processing apparatus 102 has functions of a UI provision unit 311, an account creation unit 312, an account recovery information request unit 313, an email transmission unit 316, an email address existence determination unit 317, and an account recovery processing unit 318. Further, the account recovery information request unit 313 includes a domain acquisition unit 314 and a domain match determination unit 315. Further, the information processing apparatus 102 secures a storage area in the external storage device 203 for storing a user information storage unit 319 and a domain information storage unit 320.

In response to the request from the client terminal 101, the UI provision unit 311 returns web pages and various kinds of screens used by a user to perform login processing, new registration processing, and password resetting processing.

The account creation unit 312 receives an account creation request from the client terminal 101, and stores information about the request in the user information storage unit 319 in a case where the account creation unit 312 has received a proper request. An account of the user is created if the information about the request is stored in the user information storage unit 319. When the account is created, the user can access the web service by logging in to the account. The account creation request includes user information required for the account creation, such as a user name, an email address, and a password, and also includes user information required for account recovery, such as a telephone number, a second email address, and a secret question. Hereinbelow, the user information required for the account creation may also be referred to as first user information. Further, the user information required for the account recovery, which will be described below, may also be referred to as second user information. Further, the account creation unit 312 manages the user's account in such a manner that the account is constantly able to be used by the user.

The account recovery information request unit 313 performs processing to prompt the client terminal 101 to input the second user information in a case where the account creation request is determined to satisfy a predetermined condition when the account creation unit 312 receives the account creation request. More specifically, in a case where the domain name of the email address in the account creation request is determined to match a predetermined domain name, and the second user information is not included in the account creation request, the account recovery information request unit 313 performs the processing to prompt the client terminal 101 to input the second user information.

The domain acquisition unit 314 acquires a domain information management table from the domain information storage unit 320. The domain information management table holds a list of domain names of email addresses that are able to be used only during the period of contract with a mobile-phone company or an Internet line vendor (provider).

The domain match determination unit 315 determines whether a character string included in the domain information management table acquired by the domain acquisition unit 314 fully matches or partially matches the domain name of the email address included in the account creation request. For example, in a case where the information about the domain name held in the domain information management table is “mobphone.*” and the domain name of the email address included in the request is “kentankamobphone.co.jp”, the domain match determination unit 315 determines that the domain names partially match each other.

The email transmission unit 316 transmits an email to the email address in a case where processing involving an email transmission is performed. More specifically, in a case where the information processing apparatus 102 receives a password reset request from the client terminal 101, the email transmission unit 316 transmits, to the designated email address, a password reset link with session information for performing a password reset added. The password reset link is a Uniform Resource Locator (URL) for performing password update.

In a case where an error is returned to the email transmission unit 316 from the transmission destination email server, the email address existence determination unit 317 determines whether the email address is invalid based on the content of the error. Examples of the error returned from the email server includes “the email address does not exist”, “the email box is full beyond the capacity limit”, and “the size of the transmitted email exceeds the upper limit”.

The account recovery processing unit 318 performs account recovery processing. The account recovery processing is processing for recovering the account of the user who has been deprived of access to their email address and has lost their password. The user can access the web service by logging in to the service using their own account. However, in the case where the user no longer has access to the email address and has lost their password, the user cannot log in to the web service. In such a case, the account recovery processing unit 318 authenticates the user who has transmitted the password reset request using the second user information stored in the user information storage unit 319 in order for the user to use the account again.

The user information storage unit 319 stores, for each user, user information, such as a user name, an email address, a password, a telephone number, a second email address, and a secret question. The information processing apparatus 102 authenticates a user who has made a login request (login processing). When the login processing is preformed after the creation of the account, the information about the email address and the password stored in the user information storage unit 319 is used.

The domain information storage unit 320 manages the domain names of email addresses that are able to be used only during the period of contract with a mobile telephone company or an Internet line vendor (provider). As a management form of the domain names, the domain information storage unit 320 may hold an entire character string representing the domain, such as “carriermail.co.jp”, or may hold a part of the character string representing the domain, such as “mobphone.*”. The domain names managed by the domain information storage unit 320 are updated as appropriate by an administrator of the information processing apparatus 102.

FIG. 3B illustrates an example of the functional configuration of the information processing system in a case where an account recovery information request unit functions on the client terminal 101 side. Hereinbelow, the same components as those in FIG. 3A are assigned the same reference numerals, and the redundant descriptions thereof are omitted.

The client application 302 of the client terminal 101 in FIG. 3B includes an account recovery information request unit 322, a domain acquisition unit 323, and a domain match determination unit 324, in addition to an account creation request unit 321.

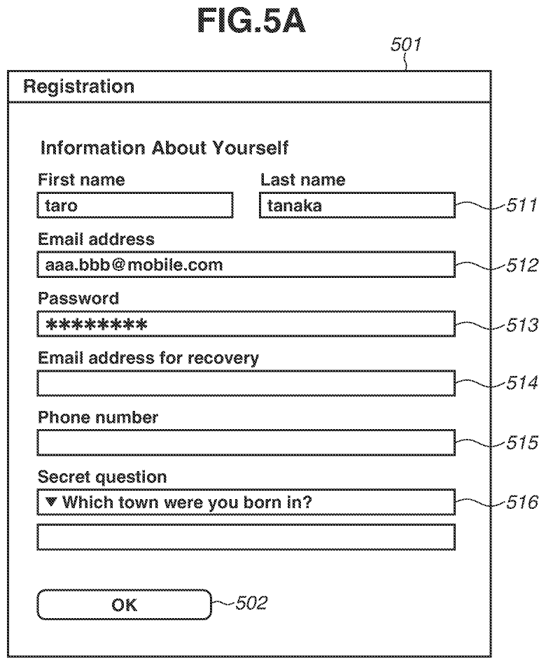

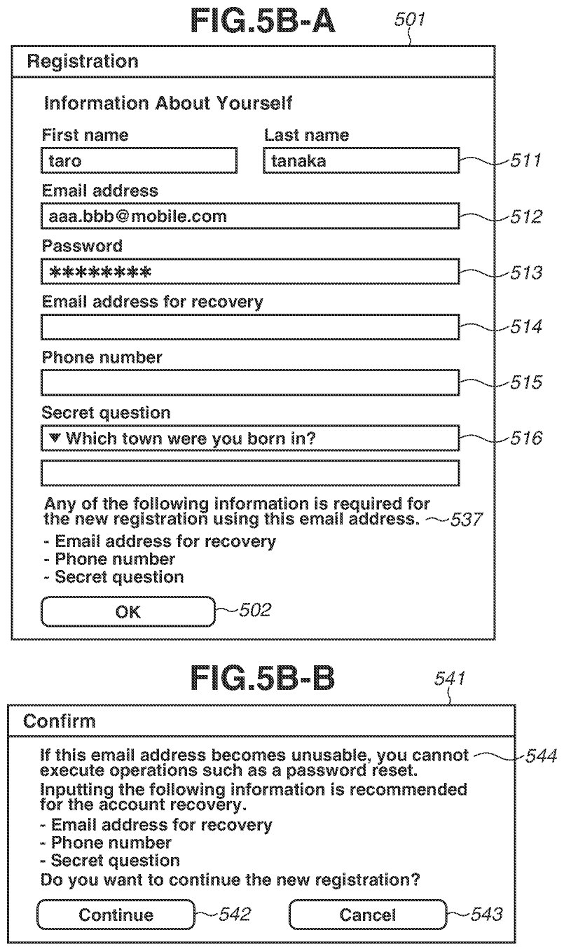

In a case where information input by a user to a new registration screen (see FIG. 5A) is correct, the account creation request unit 321 transmits an account creation request including the input information to the information processing apparatus 102. In this case, the account recovery information request unit 322 verifies the content of the account creation request. In a case where the account recovery information request unit 322 determines that the second user information needs to be input, the account creation request unit 321 stops the transmission of the account creation request, and performs processing to prompt the user to input the second user information.

The account recovery information request unit 322 determines whether to stop the transmission of the account creation request based on the input information of the account creation request unit 321, depending on a result of the determination by the domain match determination unit 324 and the presence/absence of the second user information. More specifically, in a case where the domain match determination unit 324 determines that the domains match each other, and the second user information is not included in the account creation request, the account recovery information request unit 322 determines that the second user information needs to be input and stops the transmission of the account creation request.

The domain acquisition unit 323 transmits an HTTP request to the information processing apparatus 102 to acquire a domain name from the domain information storage unit 320 of the information processing apparatus 102.

The domain match determination unit 324 has a function equivalent to that of the domain match determination unit 315 in FIG. 3A, and the domain match determination unit 324 also determines whether a character string of the domain name acquired by the domain acquisition unit 323 fully matches or partially matches the domain name of the email address included in the request.

The information processing apparatus 102 in FIG. 3B has functions of the UI provision unit 311, the account creation unit 312, the email transmission unit 316, the email address existence determination unit 317, and the account recovery processing unit 318. Further, the information processing apparatus 102 secures a storage area for storing the user information storage unit 319 and the domain information storage unit 320 in the external storage device 203. The domain information storage unit 320 has a function of returning a domain name held therein in response to the HTTP request from the client terminal 101.

Hereinbelow, as illustrated in FIG. 3A, a description is given assuming that the account recovery information request unit functions on the information processing apparatus 102 side.

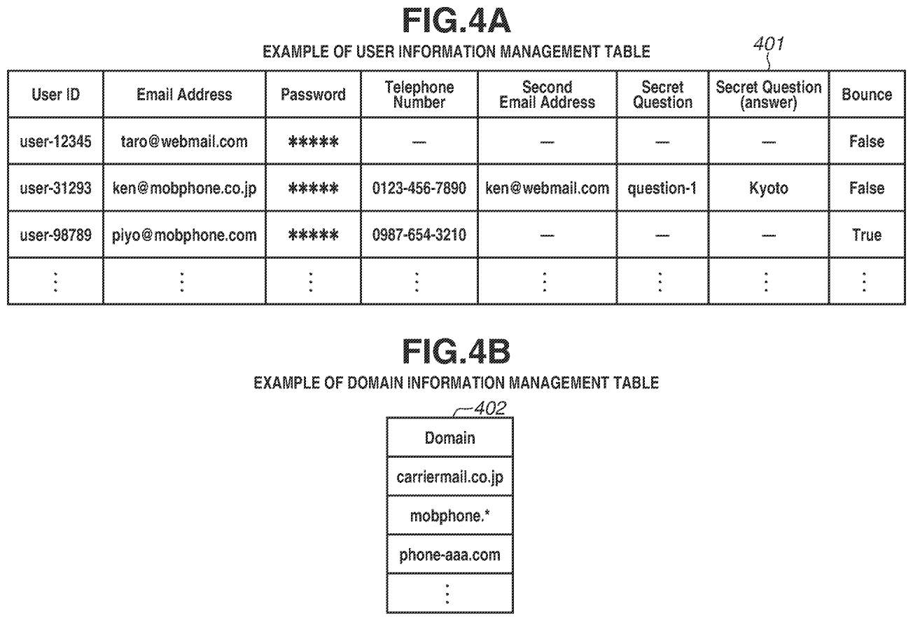

FIG. 4A illustrates an example of a user information management table 401 held in the user information storage unit 319. The user information management table 401 holds records including user information.

Each record includes information such as a user identification (ID), an email address, a password, a telephone number, a second email address, a secret question/answer, and a Bounce. However, each record may not include the information about the telephone number, the second email address and the secret question/answer. The user ID is a number to uniquely identify a user and is issued by the account creation unit 312. The information of each record corresponds to information input by a user at a time of new registration. The information of the Bounce is a true/false value indicating that the registered email address does not exist and the transmission has failed, and “False” is set in the Bounce at a time of new registration. After the new registration, “True” is set to the Bounce at a stage when the email address existence determination unit 317 determines that the email address is invalid based on an error response returned from the email server when a function involving an email transmission is used.

FIG. 4B illustrates an example of a domain information management table 402 held in the domain information storage unit 320. The domain information management table 402 holds a list of character strings each indicating a domain name. The domain information management table 402 is a table for managing the domain names of email addresses that are associated with respective contracts and could become unusable if any change is made to the corresponding contract.

As a management form of the domain names, the domain information management table 402 may hold an entire character string representing the domain, such as “carriermail.co.jp”, or may hold a part of a character string representing the domain name, such as “mobphone.*”.

### New Registration Processing

Next, the new registration processing performed by the information processing system according to the present exemplary embodiment will be described.

FIG. 5A illustrates an example of a new registration screen 501, which is a UI screen displayed when a user performs a new registration. The new registration screen 501 is provided from the information processing apparatus 102 and is displayed on the display unit 215 in a case where a user requests a new registration via a web page provided by the information processing apparatus 102. The new registration screen 501 includes input items 511 to 516. A user can input a name in the input item 511, an email address in the input item 512, and a password in the input item 513, via the input unit 216. Further, the user can input a second email address in the input item 514, a telephone number in the input item 515, and a selection of a secret question and an answer to the question in the input item 516. In the present exemplary embodiment, basically, the input items 511 to 513 (name, email address, and password) are required input items, and the input items 514 to 516 (second email address, telephone number, and secret question) are optional input items. The input items 514 to 516 are changed to required input items depending on a condition. The condition is a condition that the domain of the input email address matches a predetermined domain. In a case where the condition is satisfied, the information processing apparatus 102 outputs an error message 537 as illustrated in FIG. 5B-A, and controls the new registration processing not to be completed unless at least one of the input items 514 to 516 (second email address, telephone number, and secret question) is input. When a registration button (“OK” button) 502 is pressed, the client terminal 101 checks whether the required input items are input, and transmits an account creation request to the information processing apparatus 102.

FIGS. 5B-A and 5B-B are examples of screens to request information that is required to recover the account when a new registration is performed. The new registration screen 501 in FIG. 5B-A and a pop-up window 541 in FIG. 5B-B are displayed on the display unit 215 in a case where the information processing apparatus 102 determines that the predetermined condition is satisfied after the account creation request is transmitted. The predetermined condition is a condition that the domain of the input email address matches the domain included in the domain information management table 402. Since the email address having the domain that matches the domain included in the domain information management table 402 has a possibility of becoming unusable due to a change of the user's contract type, the user has a high risk of losing a means for recovering their account. Thus, in a case where the information required for recovering the account is not input on the new registration screen 501, the information processing apparatus 102 blocks the registration by displaying the error message 537 illustrated in FIG. 5B-A, or warns the user by displaying the pop-up window 541 illustrated in FIG. 5B-B. In this way, the information processing apparatus 102 prompts the user to input the second user information (user information required for account recovery). Whether to perform the processing of displaying the error message 537 in FIG. 5B-A or perform the processing of displaying the pop-up window 541 in FIG. 5B-B depends on the settings of the information processing apparatus 102.

The new registration screen 501 in FIG. 5B-A is similar to the new registration screen 501 in FIG. 5A with only the difference of the error message 537 additionally displayed on the new registration screen 501 in FIG. 5A. In a case where the process of the new registration is to be blocked by displaying the error message 537, the information processing apparatus 102 performs account creation processing only in a case where the information processing apparatus 102 receives the account creation request including the second user information after the error message 537 is displayed.

The pop-up window 541 in FIG. 5B-B includes a message 544 for prompting the user to input the second user information (user information required for account recovery), a continue button 542, and a cancel button 543. In a case where the continue button 542 is pressed, the information processing apparatus 102 continues the account creation processing. On the other hand, in a case where the cancel button 543 is pressed, the client terminal 101 closes the display of the pop-up window 541, and displays the new registration screen 501 in FIG. 5A. Then, the user can input the second email address, the telephone number, and the secret question using the new registration screen 501 in FIG. 5A.

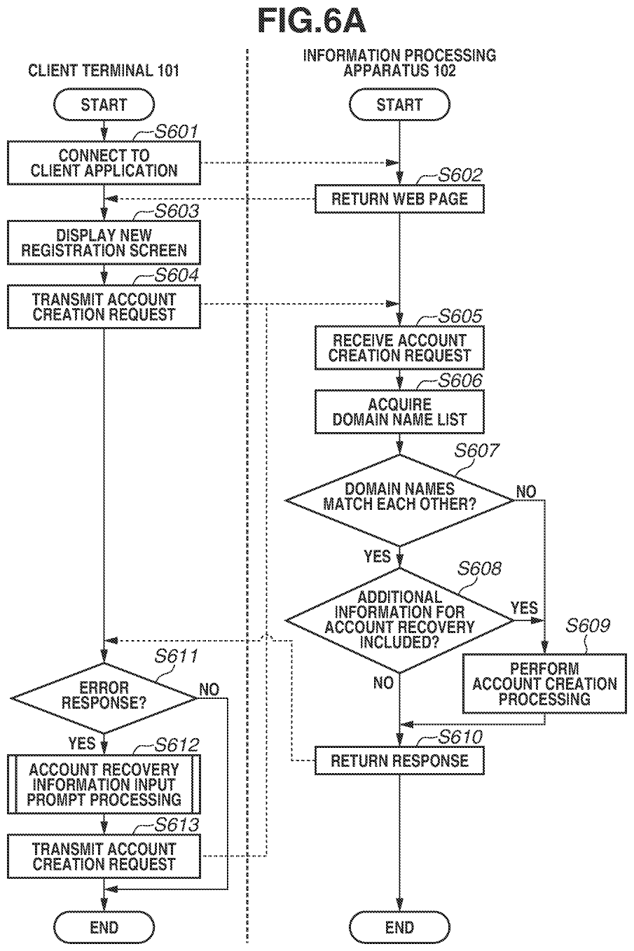

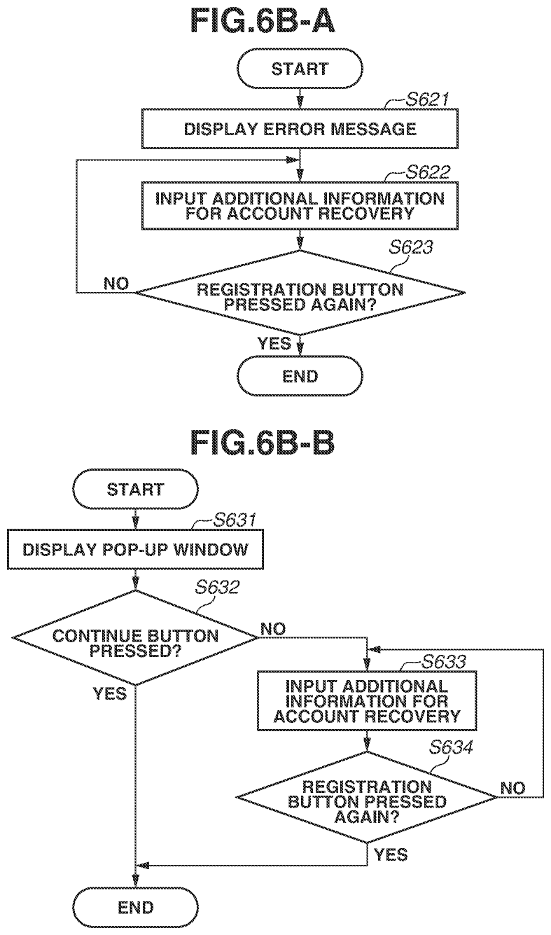

Next, with reference to a flowchart in FIG. 6A, the new registration processing performed by the information processing system according to the present exemplary embodiment will be described.

In step S601, the client terminal 101 is connected to an application hosted by the information processing apparatus 102 using the browser 301.

In step S602, the UI provision unit 311 of the information processing apparatus 102 returns, to the client terminal 101, a client application including a web screen and a program operable on the client terminal 101.

In step S603, the UI provision unit 311 of the information processing apparatus 102 causes the client terminal 101 to display the new registration screen 501 in FIG. 5A on the display unit 215 via the client application 302 of the client terminal 101, in response to an operation performed by the user to request the new registration on the web screen.

In step S604, the client terminal 101 receives the inputs to the input items 511 to 516 of the new registration screen 501 in FIG. 5A. In the present exemplary embodiment, basically, the input items 511 to 513 (name, email address, and password) are required input items, and the input items 514 to 516 (second email address, telephone number, and secret question) are optional input items, as described above.

When the user presses the registration button (“OK” button) 502 on the new registration screen 501, the client terminal 101 transmits an account creation request including the input information to the information processing apparatus 102.

The account creation request is a registration request for an account.

In step S605, the account creation unit 312 of the information processing apparatus 102 receives the account creation request. Then, the account recovery information request unit 313 of the information processing apparatus 102 starts processing for verifying the received account creation request.

In step S606, the domain acquisition unit 314 of the information processing apparatus 102 acquires the list of domain names held in the domain information management table 402 from the domain information storage unit 320.

In step S607, the domain match determination unit 315 of the information processing apparatus 102 compares the domain name acquired in step S606 and the domain name of the email address included in the account creation request to determine whether they match each other. For example, in a case where the domain name acquired in step S606 includes an asterisk, like “mobphone.*”, the domain match determination unit 315 determines whether the domain names partially match each other. In this case, if the domain name of the email address included in the request starts with “mobphone.”, the domain match determination unit 315 determines that they match partially. In a case where the domain name acquired in step S606 does not include an asterisk, like “carriermail.co.jp”, the domain match determination unit 315 determines whether the domain names fully match each other. In this case, the domain match determination unit 315 determines that they match each other only in a case where the domain name of the email address included in the request is “carriermail.co.jp”. In a case where the domain match determination unit 315 determines that they match each other in a partially matching manner or a fully matching manner (YES in step S607), the processing proceeds to step S608. In a case where the domain match determination unit 315 determines that they do not match each other (NO in step S607), the processing proceeds to step S609.

In step S608, the account recovery information request unit 313 of the information processing apparatus 102 determines whether the account creation request includes at least one of pieces of information required for the account recovery, such as a telephone number, a second email address, and a secret question. In a case where the account recovery information request unit 313 determines that the account creation request includes any of the pieces of the information required for the account recovery (YES in step S608), the processing proceeds to step S609. In a case where the account recovery information request unit 313 determines that none of the pieces of the information required for the account recovery is included (NO in step S608), the processing proceeds to step S610.

The case where the processing proceeds to step S610 from step S608 indicates a case where the user is trying to perform a new registration with the email address that could potentially become unable to be used by the user due to a change of the user's contract type, and the additional information for the account recovery is not input. In addition, as illustrated in a flowchart in FIG. 6B-B described below, there is a case where the account creation processing is permitted even when the additional information for the account recovery is not input. To support such a case, in a case where a “Force” flag is included in the account creation request, the account recovery information request unit 313 may control the processing to proceed to step S609.

In step S609, the account creation unit 312 of the information processing apparatus 102 performs account creation processing, and stores the information included in the request in the user information management table 401 of the user information storage unit 319. In this way, the account creation unit 312 registers the user's account.

In step S610, the account creation unit 312 of the information processing apparatus 102 transmits, to the client terminal 101, a response to the account creation request. In a case where the account creation unit 312 has succeeded in the account creation in step S609, the processing proceeds to step S610, and the account creation unit 312 returns a response indicating that the account creation is successful in step S610. Further, in the case where the processing proceeds to step S610 from step S608, the account creation unit 312 returns an error response indicating that the additional information is required to recover the account.

In step S611, the client terminal 101 receives the response to the account creation request, and determines whether the received response is an error response indicating that the additional information for the account recovery is required. In a case where the client terminal 101 determines that the received response is an error response (YES in step S611), the processing proceeds to step S612. On the other hand, in a case where the client terminal 101 determines that the received response is a response indicating that the account creation is successful (NO in step S611), the processing of the flowchart ends.

In step S612, the client terminal 101 performs processing to prompt the user to input the additional information (telephone number, second email address, and secret question) required for the account recovery via the client application 302 under the control of the information processing apparatus 102. Details of the recovery information input prompt processing executed in step S612 will be described below with reference to FIGS. 6B-A and 6B-B.

In step S613, the client terminal 101 transmits an account creation request including the input information again to the information processing apparatus 102. Then, the processing proceeds to step S605 again, and the account creation unit 312 of the information processing apparatus 102 performs verification of the account creation request. Then, in a case where the account recovery information request unit 313 of the information processing apparatus 102 determines that the account creation request includes any of a telephone number, a second email address, and a secret question (YES in step S608), the processing proceeds to step S609. In step S609, the account creation unit 312 of the information processing apparatus 102 performs the account creation processing. In addition, in a case where the continue button 542 in FIG. 5B-B is pressed, the account creation request may include a “Force” flag.

Next, an example of the recovery information input prompt processing performed in step S612 in FIG. 6A will be described.

FIG. 6B-A is a flowchart illustrating an example of the recovery information input prompt processing in a case where an error message is output to block the new registration processing from being continued and to request the user to input the additional information.

In step S621, the UI provision unit 311 of the information processing apparatus 102 causes the client terminal 101 to display the error message 537 on the new registration screen 501, as illustrated in FIG. 5B-A, via the client application 302 of the client terminal 101. The error message 537 includes the content to prompt the user to input a second email address (input item 514), a telephone number (input item 515), and a secret question (input item 516).

In step S622, the client terminal 101 receives the inputs of the input items 514 to 516 on the new registration screen 501. Upon confirming the error message 537, the user inputs at least any one of the second email address (input item 514), the telephone number (input item 515), and the secret question (input item 516).

In step S623, the client terminal 101 detects whether the registration button (“OK” button) 502 on the new registration screen 501 is pressed again. When the registration button 502 on the new registration screen 501 is not pressed again (NO in step S623), the processing returns to step S622. The processing continues to return to step S622 until the client terminal 101 detects that the registration button 502 on the new registration screen 501 is pressed again. On the other hand, when the client terminal 101 detects that the registration button 502 on the new registration screen 501 is pressed again (YES in step S623), the processing of this flowchart ends to proceed to step S613 in FIG. 6A.

FIG. 6B-B is a flowchart illustrating an example of the recovery information input prompt processing in a case where the pop-up window 541 is displayed to request the user to issue an instruction indicating whether to continue the new registration processing.

In step S631, the UI provision unit 311 of the information processing apparatus 102 causes the client terminal 101 to display the pop-up window 541 illustrated in FIG. 5B-B on the display unit 215 via the client application 302 of the client terminal 101. The pop-up window 541 displays the message 544 including the content that prompts the user to input a second email address, a telephone number, and a secret question. Further, the pop-up window 541 also includes the continue button 542 for issuing an instruction to continue the new registration processing, and the cancel button 543 for issuing an instruction to stop the new registration processing.

In step S632, the client terminal 101 detects whether the continue button 542 is pressed. When the client terminal 101 detects that the continue button 542 is pressed (YES in step S632), the processing of the flowchart ends to return to step S613 in FIG. 6A. In addition, in this case, to cause the information processing apparatus 102 to execute the account creation processing, the account creation request in step S613 may include a “Force” flag. In a case where the information processing apparatus 102 receives an account creation request including the “Force” flag, the information processing apparatus 102 executes the account creation processing even if the account creation request does not include the information required for the account recovery. In a case where the client terminal 101 detects that the cancel button 543 is pressed (NO in step S632), the client terminal 101 returns the display on the display unit 215 to the new registration screen 501 in FIG. 5A, and then the processing proceeds to step S633. Processing in steps S633 and S634 is similar to that in steps S622 and S623, and thus the descriptions thereof are omitted.

Then, the processing of the flowchart ends to proceed to step S613 in FIG. 6A.

According to the flowcharts in FIGS. 6A, 6B-A, and 6B-B described above, the new registration processing according to the present exemplary embodiment can be performed.

According to the flowcharts described above, it is possible to request a user to input additional information required for account recovery only when the user is trying to perform a new registration with an email address that could potentially become unable to be used by the user due to a change of the user's contract type. This allows the user to reset their password to log in to their account by using the additional information registered at the time of new registration, even in a case where the user's email address becomes unusable in the future and the user has lost their password to log in to their account. Further, in a case where the email address that the user uses for the new registration does not correspond to such an email address that could possibly become unusable because of a change of the contract type, the user will not be requested to input additional information, thereby being able to secure convenience for the user as much as possible.

Further, the flowcharts described above illustrate the flows of processing in the configuration in which the account recovery information request unit 313 is included in the information processing apparatus 102, as illustrated in FIG. 3A. However, the account recovery information request unit 313 may be included in the client terminal 101 side, as illustrated in FIG. 3B. In this case, the processing performed in steps S606 to S608 in FIG. 6A is performed by the account recovery information request unit 322, the domain acquisition unit 323, and the domain match determination unit 324 in the client application 302. The account recovery information request unit 322 determines whether the condition that the domains match each other and the input information does not include additional information required for the account recovery is satisfied, at a stage when the registration button (“OK” button) 502 on the new registration screen 501 is detected to be pressed. Then, in a case where the account recovery information request unit 322 determines that the above-described condition is satisfied, the processing similar to that in step S612 is performed.

### Processing Related to Password Resetting

Next, processing related to password resetting executed by the information processing system according to the present exemplary embodiment will be described. In the present exemplary embodiment, in a case where a user has forgotten their password and cannot log in to their account, the information processing apparatus 102 updates the password after performing the account recovery processing and authenticating the user.

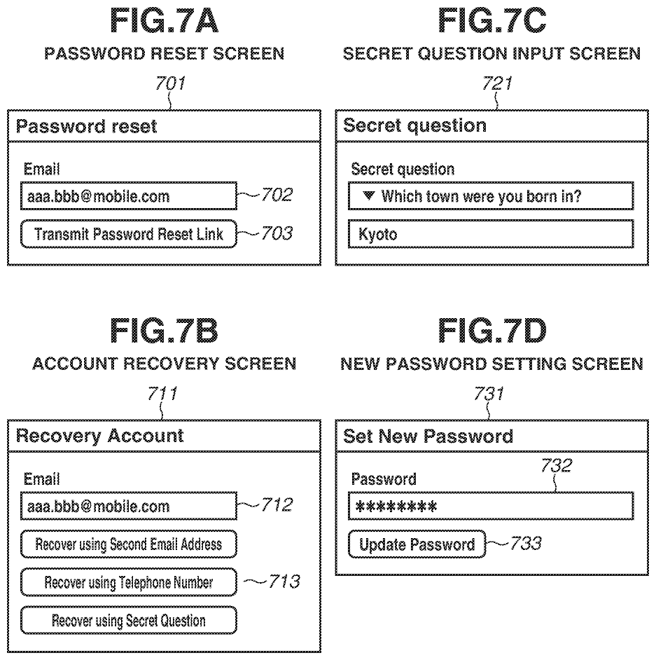

A screen illustrated in each of FIGS. 7A, 7B, 7C, and 7D is an example of a web page presented to the user in the processing related to the password resetting.

FIG. 7A illustrates a password reset screen 701. In response to a password reset request from the user, the UI provision unit 311 of the information processing apparatus 102 causes the client terminal 101 to display the password reset screen 701 on the display unit 215 via the client application 302 of the client terminal 101. The password reset screen 701 is a screen used by a user who has forgotten their password to reset the password. The password reset screen 701 includes an input field 702 for inputting an email address, and a transmission button 703 for transmitting a password reset link.

When the transmission button 703 is pressed, the client terminal 101 transmits a password reset request including the email address input in the input field 702, to the information processing apparatus 102. The email transmission unit 316 of the information processing apparatus 102 transmits the password reset link to the email address included in the password reset request.

FIG. 7B illustrates an account recovery screen 711. The UI provision unit 311 of the information processing apparatus 102 causes the client terminal 101 to display the account recovery screen 711 on the display unit 215 via the client application 302 of the client terminal 101, in a case where the password resetting using the password reset screen 701 cannot be performed. On the account recovery screen 711, a plurality of methods usable by a user to recover the account is displayed in a selectable manner. More specifically, the account recovery screen 711 includes an input field 712 for inputting an email address, and buttons 713 for instructing an account recovery using a second email address, a telephone number, and a secret question.

FIG. 7C illustrates a secret question input screen 721. The UI provision unit 311 of the information processing apparatus 102 causes the client terminal 101 to display the secret question input screen 721 on the display unit 215 via the client application 302 of the client terminal 101, in a case where the user selects the account recovery using the secret question on the account recovery screen 711. The secret question input screen 721 includes a pull-down menu to display the secret question set by the user in advance, and an input box for inputting the answer to the secret question.

FIG. 7D illustrates a new password setting screen 731. The new password setting screen 731 is a screen displayed on the display unit 215 in a case where the user presses the password reset link transmitted from the information processing apparatus 102. The new password setting screen 731 includes an input box 732 for inputting a password, and an update button 733 for instructing a password update using the input password.

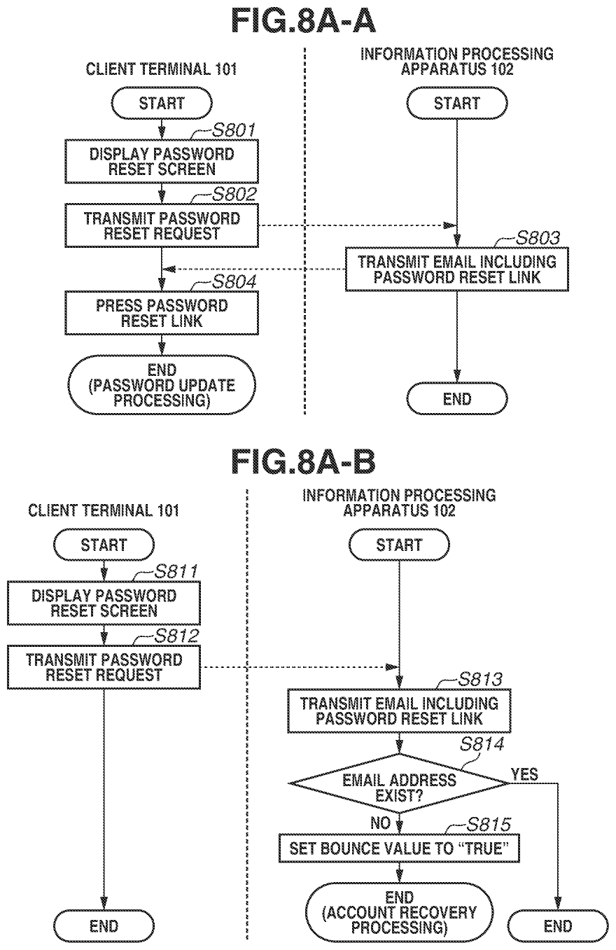

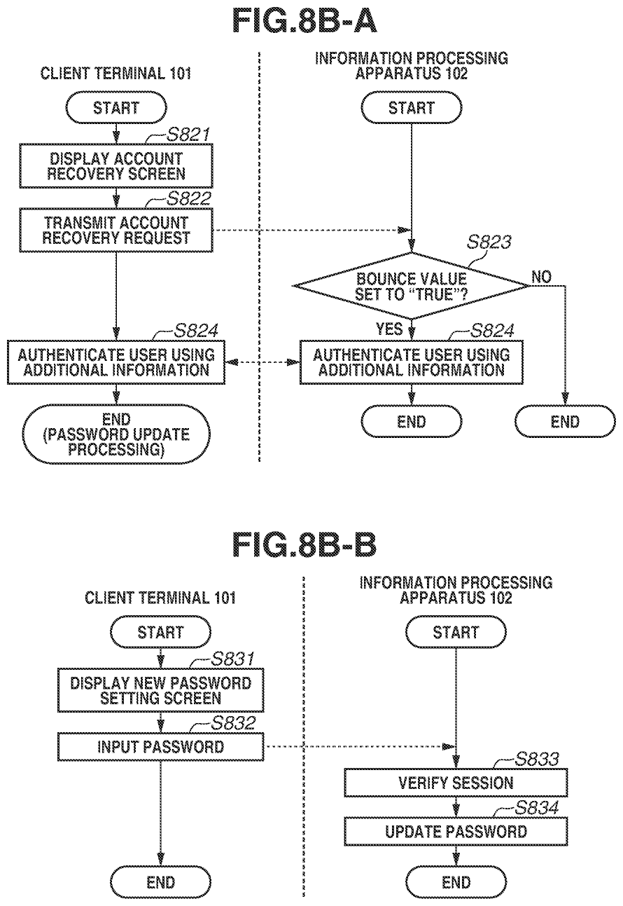

Next, details of the processing related to the password resetting will be described with reference to FIGS. 8A-A, 8A-B, 8B-A, and 8B-B. In a case where a user has forgotten their password, the password set in the account needs to be changed so as to allow the user to log in to the account. However, if a third person can reset the password, there is a risk that the user's account may be taken over by the third person. Thus, in the present exemplary embodiment, the password update is performed after user authentication is performed using a method other than the method using password check. Examples of a method of performing the password update after performing identification of a person is performed using a method other than the password check includes the following four methods.
(1) Transmitting a password reset link with unguessable session information added thereto, to the registered email address.
(2) Transmitting a password reset link with unguessable session information added thereto, to the short message service (SMS) of the registered telephone number.
(3) Transmitting a password reset link with unguessable session information added thereto, to the registered second email address.
(4) Requesting a user to input an answer to the registered secret question, and shifting the page to a password reset page with unguessable session information added thereto only in a case where the answer is correct.

In the above-described methods (1), (2), and (3), the identification of a user is implicitly performed based on an assumption that only the user themselves can access the email address or the SMS of the telephone number, and in the method (4), the identification of a user is performed based on an assumption that only the user themselves knows the answer to the secret question. Hereinbelow, as for the methods (1) to (4), a specific method of the method (1) and a specific method in which the methods (2), (3) and (4) are performed only in a case where the method (1) cannot be used will be described.

### Processing Performed in Response to Password Reset Request (Normal System)

FIG. 8A-A is a flowchart illustrating a method of performing a password reset by the information processing system according to the present exemplary embodiment, using a registered valid email address.

In step S801, the UI provision unit 311 of the information processing apparatus 102 causes the client terminal 101 to display the password reset screen 701 on the display unit 215, in response to an operation issued by the user to request a password reset on the web page provided by the information processing apparatus 102.

In step S802, when the user inputs an email address to the input field 702 and presses the transmission button 703 for transmitting the password reset link, the client terminal 101 transmits a password reset request to the information processing apparatus 102.

In step S803, upon receiving the password reset request, the information processing apparatus 102 issues a password reset link with unguessable session information added thereto. Then, the email transmission unit 316 of the information processing apparatus 102 transmits an email including the password reset link to the email address included in the request. Before transmitting the email, the email transmission unit 316 may refer to the information in the user information management table 401, and perform control to transmit the email only in a case where the email address included in the request is a registered email address. In addition, the character string representing the session information added to the password reset link is stored in the RAM 202 of the information processing apparatus 102.

In step S804, when the client terminal 101 detects that the password reset link transmitted from the information processing apparatus 102 is pressed by the user, the client terminal 101 determines that the user authentication has succeeded, and the processing proceeds to password update processing in FIG. 8B-B.

### Processing Performed in Response to Password Reset Request (Abnormal System)

Next, with reference to FIGS. 8A-B, 8B-A, and 8B-B, a method of resetting a password in a case where the email address is unusable will be described. FIG. 8A-B is a flowchart illustrating processing performed by the information processing system according to the present exemplary embodiment in a case where the registered email address does not exist (i.e., the registered email address is in an invalid state).

In steps S811 to S813, processing similar to that in steps S801 to S803 in FIG. 8A-A is performed. In step S813, if the email address does not exist, a destination email server may return an error response.

In step S814, the email address existence determination unit 317 of the information processing apparatus 102 receives the error response from the email server, and determines whether the email address exists from the content of the error message. In a case where the email address existence determination unit 317 determines that the email address does not exist (NO in step S814), the processing proceeds to step S815. In a case where the email address existence determination unit 317 cannot determine whether the email address exists, for example, in a case where no error response is received (YES in step S814), the processing of this flowchart ends. Alternatively, the processing may proceed to step S804. More specifically, in the case where the email address existence determination unit 317 cannot confirm that the email address is invalid, the information processing apparatus 102 performs the user authentication based on whether the password reset link transmitted to the designated email address is detected to be pressed.

In step S815, the email address existence determination unit 317 refers to the information in the user information management table 401, and sets the Bounce value of the record including the email address included in the request to “True”. Then, the processing proceeds to processing related to the account recovery illustrated in FIG. 8B-A.

### Processing Related to Account Recovery

FIG. 8B-A illustrates a method of performing user authentication in a case where the registered email address does not exist (i.e., the registered email address is in an invalid state).

In step S821, the UI provision unit 311 of the information processing apparatus 102 causes the client terminal 101 to display the account recovery screen 711 on the display unit 215. The account recovery screen 711 may be displayed in response to a user operation performed on the web page provided by the information processing apparatus 102, or may be displayed when the processing in step S815 in FIG. 8A-B is performed.

In step S822, the client terminal 101 receives, on the account recovery screen 711, the input of the email address in the input field 712, and the press of any of the buttons 713 of “recovery using the second email address”, “recovery using the telephone number”, and “recovery using the secret question”. The client terminal 101 transmits an account recovery request including the email address and the recovery method, to the information processing apparatus 102.

In step S823, the account recovery processing unit 318 of the information processing apparatus 102 receives the account recovery request, and searches the user information management table 401 for the user's record including the email address in the request. Then, the account recovery processing unit 318 checks whether the Bounce value of the record is set to “True”. In a case where the account recovery processing unit 318 determines that the Bounce value is “True” (YES in step S823), the processing proceeds to step S824. On the other hand, in a case where the account recovery processing unit 318 determines that the Bounce value is “False” (NO in step S823), the account recovery processing unit 318 cannot confirm that the email address does not exist, and thus the processing of this flowchart ends. As described above, in the present exemplary embodiment, the user authentication using the additional information required for the account recovery is permitted only in the case where the email address is invalid (i.e., the Bounce value is True).

In step S824, the account recovery processing unit 318 performs the user authentication in cooperation with the client terminal 101 in a different method depending on the selected recovery method in the account recovery request. First, as common processing, the account recovery processing unit 318 acquires the user's record (user information) including the email address in the account recovery request from the user information management table 401 in advance.

In a case where the recovery using the second email address is selected, the account recovery processing unit 318 checks whether a second email address is included in the user information. If a second email address is included, the account recovery processing unit 318 transmits a password reset link to the second email address. When the user presses the password reset link, the processing proceeds to password update processing in FIG. 8B-B.

In a case where the recovery using the telephone number is selected, the account recovery processing unit 318 checks whether a telephone number is included in the user information. If a telephone number is included, the account recovery processing unit 318 transmits the password reset link to the telephone number using the SMS. When the user presses the password reset link, the processing proceeds to password update processing in FIG. 8B-B.

In a case where the recovery using the secret question is selected, the account recovery processing unit 318 checks whether a secret question is included in the user information. If a secret question is included, the UI provision unit 311 causes the client terminal 101 to display the secret question input screen 721 on the display unit 215. Assume that a predetermined question set in advance by the user is displayed in the secret question field on the secret question input screen 721. The client terminal 101 receives the input of a user's answer to the secret question, and transmits the received answer to the information processing apparatus 102. The account recovery processing unit 318 refers to the answer to the secret question. When the answer is correct, the account recovery processing unit 318 returns a response to the client terminal 101 so that the screen of the client terminal 101 is redirected to the new password setting screen 731, and then the processing proceeds to password update processing in FIG. 8B-B.

Further, in step S824, the information processing apparatus 102 issues a character string representing unguessable session information and stores it in the RAM 202 of the information processing apparatus 102, when the information processing apparatus 102 issues the password reset link or causes the screen of the client terminal 101 to be redirected to the new password setting screen 731.

### Password Update Processing

Next, with reference to FIG. 8B-B, a method of updating a password will be described.

In step S831, the UI provision unit 311 of the information processing apparatus 102 causes the client terminal 101 to display the new password setting screen 731 on the display unit 215. The new password setting screen 731 is displayed when the processing (normal system) performed in response to the password reset request in FIG. 8A-A ends, when the password reset link is pressed in the processing related to the account recovery in FIG. 8B-A, or when the answer to the secret question is correct. A character string representing session information unguessable by a third person is added to a query parameter of a URL for displaying the new password setting screen 731.

In step S832, when the password is input in the input box 732 on the new password setting screen 731 and the update button 733 is pressed, the client terminal 101 transmits a password update request including the password and the session character string to the information processing apparatus 102.

In step S833, upon receiving the password update request, the information processing apparatus 102 verifies whether the session character string matches the value held in advance. If they match each other, then in step S834, the information processing apparatus 102 updates the password. When the password is updated, the user will be able to log in to their own account using the new password.

In FIGS. 7A to 8B-B described above, the description is given of the procedure of authenticating the user using the additional information input in the new registration processing and resetting the password in the case where the user forgets their password, and the registered email address does not exist. Through the procedure, even in the case where the user has lost their password, and the registered email address has become unusable, the user can reset their password using the telephone number, the second email address, or the secret question related to the user that is registered in advance. In addition, the flowcharts in FIGS. 8A-A, 8A-B, 8B-A, and 8B-B illustrate the example in which a password reset is permitted to be performed using the telephone number, the second email address, or the secret question related to the user described above only in the case where the email address is not usable in consideration of the security aspect. As an alternative to the foregoing configuration, in consideration of improvement in the user convenience, the user may be allowed to change their password using the telephone number, the second email address, or the secret question related to the user regardless of whether the email address is usable or unusable.

As described above, according to the present exemplary embodiment, it is possible to prompt the user to input the additional information required for resetting the password at the time of new registration only in the case where the new registration is performed using the email address that could potentially become unable to be used by the user due to a change of their contract type. In this way, it is possible to reduce the risk that a user becomes unable to reset their password after registration, while preventing the decrease in the user convenience as much as possible. Further, it is possible to allow the user to reset their password using the registered additional information even in a case where the user has lost the password after the registration and the email address has become unusable.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-024959, which was filed on Feb. 21, 2023 and which is hereby incorporated by reference herein in its entirety.

What is claimed is:

1. An information processing apparatus comprising:
one or more memories; and
one or more processors, wherein the one or more processors and the one or more memories are configured to:
receive a registration request including an email address and a password from a user terminal; and
perform a registration process that registers an account of a user using the registration request,
wherein the registration process includes performing processing to prompt the user terminal to input additional information before registering the account in a case where a domain of the email address included in the registration request matches a predetermined domain.

2. The information processing apparatus according to claim 1, wherein the additional information is information to be used for user authentication in a case where the password of the account registered by the registration process is updated.

3. The information processing apparatus according to claim 1, wherein the one or more processors and the one or more memories are further configured to hold a list of domains including the predetermined domain,
wherein the registration process determines whether the domain of the email address included in the registration request matches the predetermined domain in the list of domains.

4. The information processing apparatus according to claim 1, wherein the registration process does not register the account until the one or more processors and the one or more memories receive the additional information from the user terminal after performing the processing to prompt the user terminal to input the additional information.

5. The information processing apparatus according to claim 1, wherein, in a case where the one or more processors and the one or more memories receive an instruction from the user terminal, the registration process registers the account even if the one or more processors and the one or more memories do not receive the additional information from the user terminal after performing the processing to prompt the user terminal to input the additional information.

6. The information processing apparatus according to claim 1, wherein the processing to prompt the user terminal to input the additional information is processing to cause the user terminal to display a message to prompt the user to input the additional information.

7. The information processing apparatus according to claim 1, wherein, in a case where the additional information is included in the registration request, the registration process does not include the processing to prompt the user terminal to input the additional information even if the domain of the email address included in the registration request matches the predetermined domain.

8. The information processing apparatus according to claim 1, wherein the additional information includes at least one of a second email address, a telephone number, and a secret question related to the user.

9. The information processing apparatus according to claim 1, wherein the one or more processor and the one or more memories are further configured to update the password of the account registered by the registration process.

10. The information processing apparatus according to claim 9,
wherein the registration process registers the additional information in association with the account, and
wherein the one or more processors and the one or more memories are further configured to:
authenticate the user using the additional information associated with the account in a case where the email address of the account registered by the registration process is invalid, and
authenticate the user by transmitting an email to the email address in a case where the email address of the account registered by the registration process is not invalid.

11. An information processing system including a user terminal and an information processing apparatus,
the user terminal comprising:
one or more first processors and one or more first memories that are configured to control the user terminal to transmit a registration request including an email address and a password to the information processing apparatus, and
the information processing apparatus comprising:
one or more second memories; and
one or more second processors, wherein the one or more second processors and the one or more second memories are configured to control the information processing apparatus to:
receive the registration request from the user terminal; and
perform a registration process that registers an account of a user using the registration request,
wherein the one or more first processors and the one or more first memories are further configured to control the user terminal to perform processing to prompt the user terminal to input additional information before transmitting the registration request in a case where a domain of the email address included in the registration request matches a predetermined domain.

12. An information processing method comprising:
receiving a registration request including an email address and a password from a user terminal; and
registering an account of a user using the registration request,
wherein, in the registering, processing to prompt the user terminal to input additional information is performed before the account is registered in a case where a domain of the email address included in the registration request matches a predetermined address.

13. A non-transitory storage medium storing a program causing an information processing apparatus to execute an information processing method, the information processing method comprising:
receiving a registration request including an email address and a password from a user terminal; and
registering an account of a user using the registration request,
wherein, in the registering, processing to prompt the user terminal to input additional information is performed before the account is registered in a case where a domain of the email address included in the registration request matches a predetermined address.
